(19) United States
(12) Patent Application Publication
(10) Pub. No.: US 2008/0295272 A1
(43) Pub. Date: Dec. 4, 2008

(54) Central Fixing and Connection Device for a Windscreen Wiper

(75) Inventor: Jean-Michel Jarasson, Elancourt (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, Le Mesnil-Saint-Denis (FR)

(21) Appl. No.: 12/096,494

(22) PCT Filed: Dec. 19, 2006
(86) PCT No.: PCT/EP2006/069893

§ 371 Date: Jun. 6, 2008

(30) Foreign Application Priority Data
Dec. 21, 2005 (FR) 0513004

(51) Int. Cl. B60S 1/40

(52) U.S. Cl. 15/250.32

(57) ABSTRACT

A device for supporting and attaching a wiper blade and a blade mounting thereof on a wiper carrier includes a connector including two halves connectable to each other and configured in a connected position to support and lock the blade and said blade mounting. Each connector half includes a projecting component configured to engage with a matching component, one on said blade and the other on said mounting respectively.

The present invention relates to a device for attaching and/or connecting a windscreen wiper on a wiper carrier and more particularly in the central part of said wiper.

It is known that so-called flat windscreen wipers include a wiping blade made of rubber, a plane spring blade made of an elastic material (generally made of metal) and a mounting bar generally (made of plastic material). The spring blade is generally positioned in a housing forming a sheath provided in the wiper itself. The three components (the wiping blade, the spring blade, and the plastic mounting) are connected together, on the one hand, and connected to the wiper carrier on the other hand, and to a component called a connector. The connector generally consists of two substantially symmetrical or even identical components, sandwiching the three components and is provided with attaching means between both connector halves.

In addition, the three components (the wiping blade, the spring blade and the plastic mounting) are supported together at the wiper ends, by supporting and locking components also called “end locks”.

Such known devices are liable to be improved. As a matter of fact, they include a large number of parts. This entails high manufacturing costs, on the one hand, and high mounting costs on the other hand, which could be reduced advantageously.

From U.S. Pat. No. 6,161,248 is known a windscreen wiper connection device including a central connection component made of one part having a general U shape and able to accommodate, at a base of said U, the wiper spring blade. Matching locking means are provided on said blade and said connection component more particularly in the form of an elastic lug provided on the blade, liable to engage its end into a matching component provided on the connection component.

This known device solves, only partly, the issue of the connection in longitudinal translation of the blade with respect to the connection component. Besides, the central connector is made in a single piece.

The German patent application DE 1 952 855 discloses a windscreen wiper provided with a longitudinal sheath able to accommodate the spring blade, said sheath includes notches able to accommodate the connection device between the wiper and the wiper carrier.

The European patent application EP 0 752 352 discloses a windscreen wiper provided with arms the ends of which are provided with a connection component having a general U shape, the branches of which are curved so as to engage with a longitudinal housing provided in the wiper. Thus, a main arm is associated with two end arms which results in four connectors distributed along the length of the wiper.

The problem resides in reconciling the requirements as regards the reliability and the strength of the assembly of the various parts together on the one hand, and the economical requirements which tend to reduce the number of parts and reduce the mounting time on the other hand.

The present invention aims at remedying such problem and provides a device for fixing and/or connection various windscreen wiper components on the wiper carrier which has a reduced number of parts and thus a reduced mounting time with respect to the prior art.

More precisely, according to the invention, the device for connecting and/or attaching the various components of the windscreen wiper is arranged so as not to have to take into account the requirement of using attaching or supporting components for the windscreen wiper components at the ends thereof, also called “end locks”. In other words, the supporting or attaching device according to the invention is able to support the windscreen wiper components together in a reliable way through the only central connection between the windscreen wiper proper and the wiper carrier.

For this purpose, according to the invention, the device for supporting and attaching a windscreen wiper blade and its mounting on a wiper carrier comprising a connector consisting of two halves connectable to each other, and able in the connected position to support and lock the blade and said blade mounting, is characterised in that each connector half includes a projecting component able to engage with a matching component provided on said blade and on said mounting, respectively.

Preferably, both connector halves are identical.

Additionally, notches able to engage with a matching and projecting lug provided on each connector half are provided on either side of said mounting.

The distal ends of each lug provided on each connector half are able to abut against each other in the connected position of the connector halves.

In order to improve the locking of the mounting and the blade with respect to the connector, more particularly in longitudinal translation, the distal end of each lug is provided with a projecting component able to engage with a notch provided on the other lug of the other connector half.

According to one embodiment, the blade includes a through hole provided in the transversal direction.

In an alternative embodiment, each lug provided on each connector half comprises a hole and a locking pin is provided which is able, in the connected position, to go through both lugs, the hole in the blade and the notches in the mounting.

In an alternative embodiment, each lug provided on the connector half is provided with blade locking means, the later having no hole. According to this embodiment, the locking means more particularly consist of prongs or teeth on the distal edge of each lug.

The invention also relates to a windscreen wiper assembly comprising a blade, the mounting thereof and a connector consisting of two halves including one or several of the preceding characteristics.

The invention will be better understood while reading the following description relating to illustrative and non-limitative examples and referring to the appended drawings wherein:

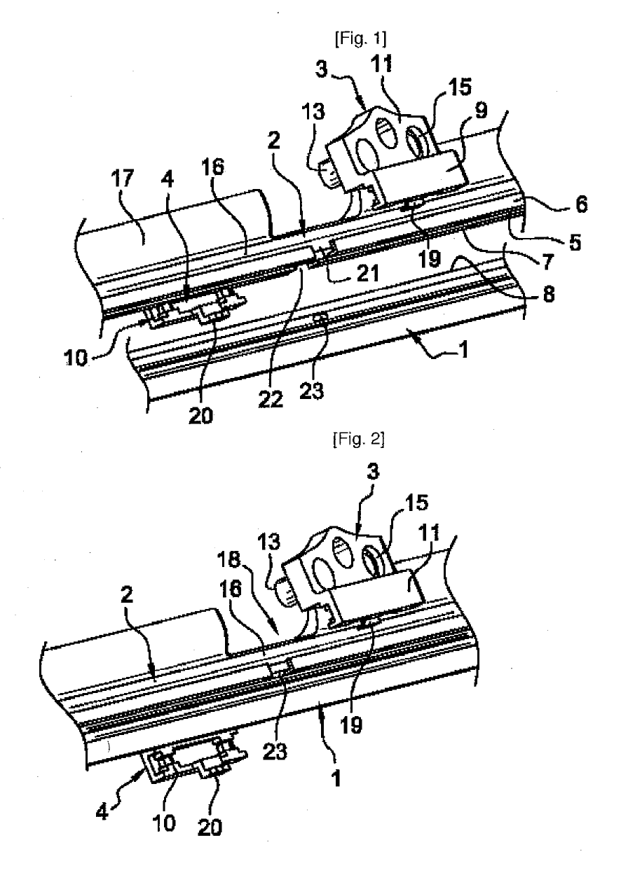

FIGS. 1-4 show a partial perspective view of a blade and the mounting thereof, associated with a connector consisting of two halves, respectively according to four assembling steps,

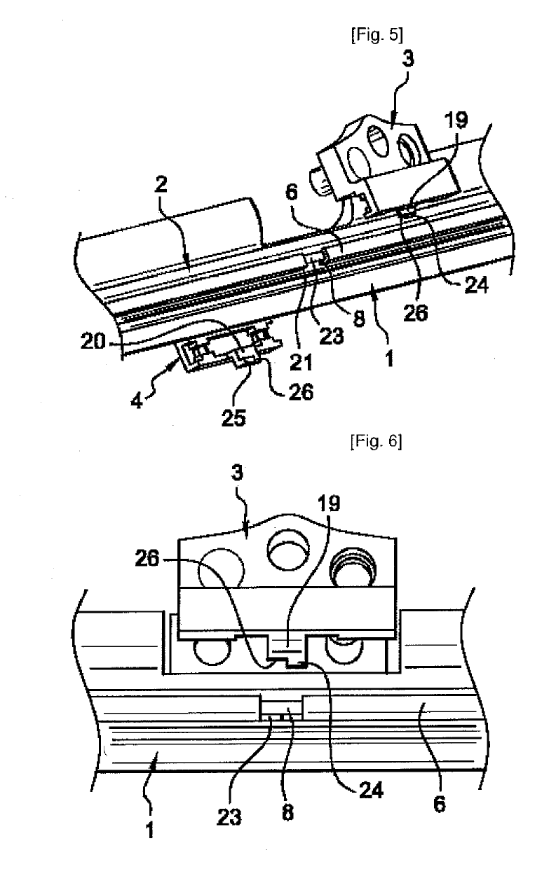

FIGS. 5, 6 and 7 show a partial perspective view of an alternative embodiment of the blade and the mounting thereof, and the associated connector according to three assembling steps,

FIGS. 8 to 11 show another alternative embodiment of the blade, the mounting thereof, the locking pin and the connector, in perspective, according to four assembling steps.

FIG. 10 shows another alternative embodiment of the locking pin.

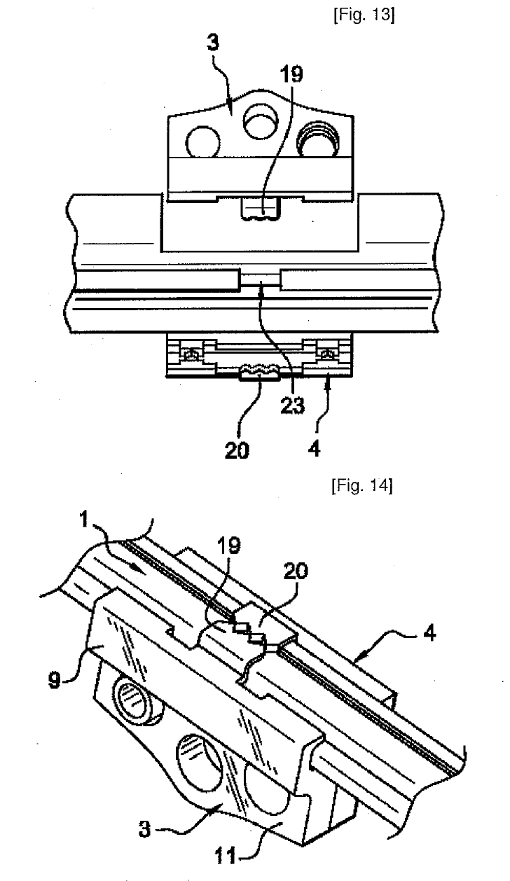

FIGS. 12, 13 and 14 show still another alternative embodiment, in perspective, of the blade, the mounting thereof and the connector, according to three assembling steps.

While referring to FIGS. 1 to 4, an embodiment of the invention is described and shown.

FIG. 1 shows a windscreen wiper blade 1 known in itself, an assembly mounting 2 made of plastic material known in itself and a connector consisting of two halves or connector halves 3 and 4 made of plastic material.

In a known way, the assembly mounting 2 is long and liable to accommodate the wiping blade 1 through a longitudinal groove 5 defined by 2 side rails 6 and 7 parallel to each other and defining a space in which the upper component 8 of the blade 1, having a matching shape, is liable to slide into position.

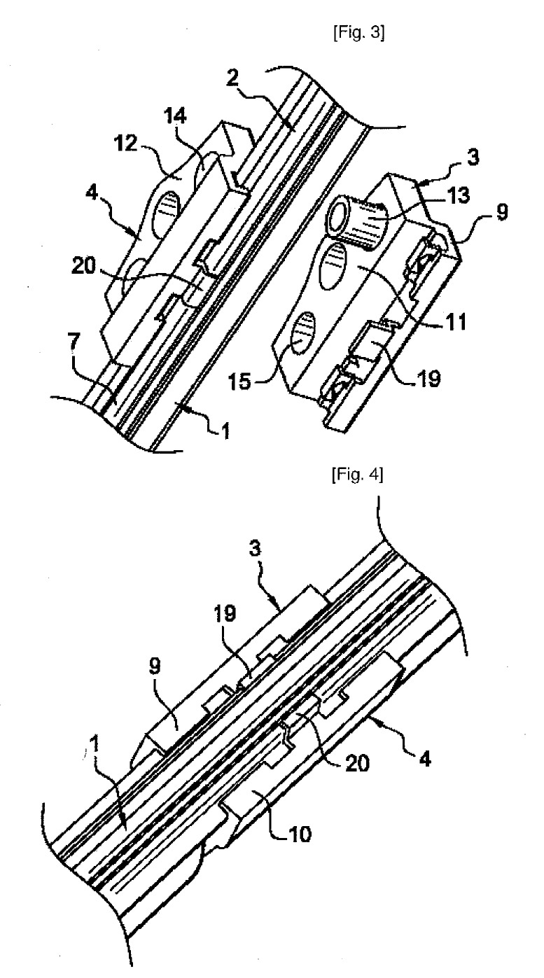

The connector consists of two halves 3 and 4 which are symmetrical. Each half has a first part (or upper part) having the general shape of a U indicated by 9 for the connector half 3 and 10 for the connector half 4. Each half also has a second part (or lower part) having a general parallelepiped or trapezoid shape, respectively indicated by 11 and 12 (the part 12 is not visible in FIGS. 1, 2 and 4 but is visible in FIG. 3.)

The second parts 11 and 12 include connection means in the form of at least one pin liable to engage in orifices provided on the other half of the connector. As a matter of fact, the connector half 3 includes a pin 13 liable to engage with a hole 14 on the other half 4. Similarly, the later includes a pin (which is not visible in FIGS. 1-4 and liable to engage with a hole 15 provided on the other connector half 3. The connection means provided on both connector halves are known in themselves.

The lower part 9, respectively 10, of each connector half 3 and 4 is able to accommodate a matching part forming a curl 16 provided on the upper part of the assembly mounting 2 (FIG. 3).

Similarly, the assembly mounting 2 includes in its upper part a deflector or a skirt 17. The deflector 17 is interrupted where both connector halves are joined together along a cut indicated by 18 (refer to FIG. 2), the dimensions of which are such that the lower assembly parts 11 and 12 of connector halves 3 and 4 can rest against each other and be attached using the previously described connection means.

Each connector half 3, 4 includes at the base of its lower part, respectively 9 and 10, (in the shape of a U and liable to accommodate the assembly mounting 2), a lug indicated respectively by 19 and 20). Each lug 19 and 20 has the general shape of an L and projects with respect to the base of the lower part 9, 10.

Notches, respectively indicated by 21 and 22 positioned opposite each other and having a shape matching that of each lug 19 and 20 provided on each connector half 3 and 4, are provided on each longitudinal rail 5-6 parallel to the assembly mounting 2.

The locking lugs 19 and 20 are positioned on each connector half 3, 4 so as to be positioned opposite each other and preferably abutting at their distal ends.

In FIGS. 1 and 2, it can be seen that the upper part 8 of the blade 1 includes an orifice 23 having a shape matching that of the lugs 19 and 20 provided on each connector half 3, 4. The orifice 23 has a general parallelepiped shape forming a rectangle when observed transversely, perpendicular to the longitudinal direction of the blade.

More precisely, as regards FIG. 4, it should be noted that the lugs 19 and 20 go through notches 21, 22 provided on the side rails 6 and 7 of the mounting 2 and rest on their upper faces, on the base of the upper part 8 of the blade 1.

Thus, a reliable locking and supporting of all the components with respect to each other, i.e. the blade 1, the mounting 2, and the connector 3, 4 is thus obtained.

In FIGS. 5 to 7 is shown, at various steps of the assembling, an alternative embodiment; the identical or similar components have the same reference numbers as in FIGS. 1 to 4.

The embodiment of FIGS. 5 to 7 is different from that of FIGS. 1 to 4, in the shape of the lugs 19 and 20.

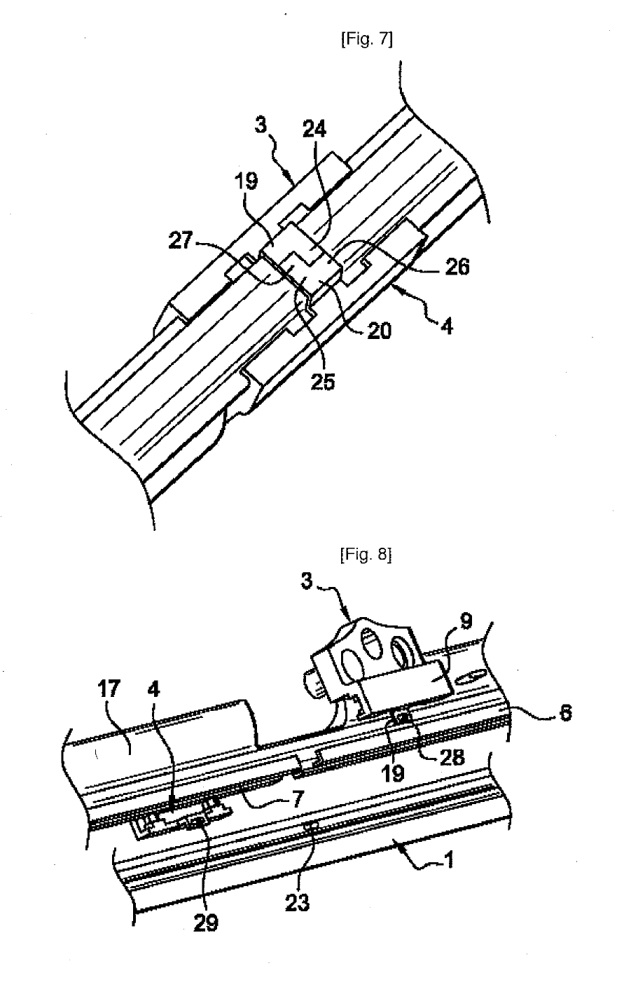

The distal part 24, 25 of each lug intended, in the connected position, to face and to abut against the distal part of the other lug, includes a notch 26, respectively 27. Each notch 26, 27 thus defines, on each lug, a projecting part positioned in a staggered way with respect to the other one, in the connected position (FIG. 7).

FIGS. 8 to 11 show, at various steps of the assembling, another embodiment in which the identical or similar components have the same reference numbers as in the previous Figures.

On such FIGS. 8 to 11, the lugs 19 and 20 consist of a thin parallelepiped component, perpendicular to the longitudinal direction of the blade and in the plane of the matching connector half 3, 4. Each lug 19, 20 projects with respect to the base (in the opposite direction with respect to the upper part 11, 12 for attaching the connector half), of the lower locking part 9, 10 of the connector half.

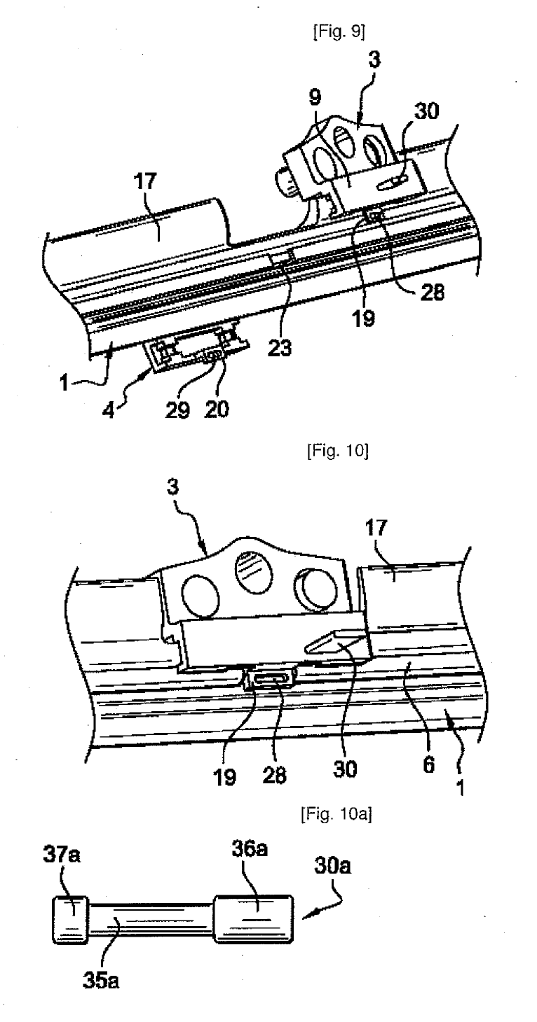

Each lug 19, 20 includes a hole, 28, 29 (FIGS. 9 and 8) preferably having a rectangular cross-section as observed in the longitudinal direction of the blade.

When the connector halves 3, 4 are assembled (FIG. 10), the lugs 19 and 20 are positioned in the notches, 21, 22 provided on the rails 6 and 7 of the mounting 2, but do not go through the hole 23 provided on the blade 1.

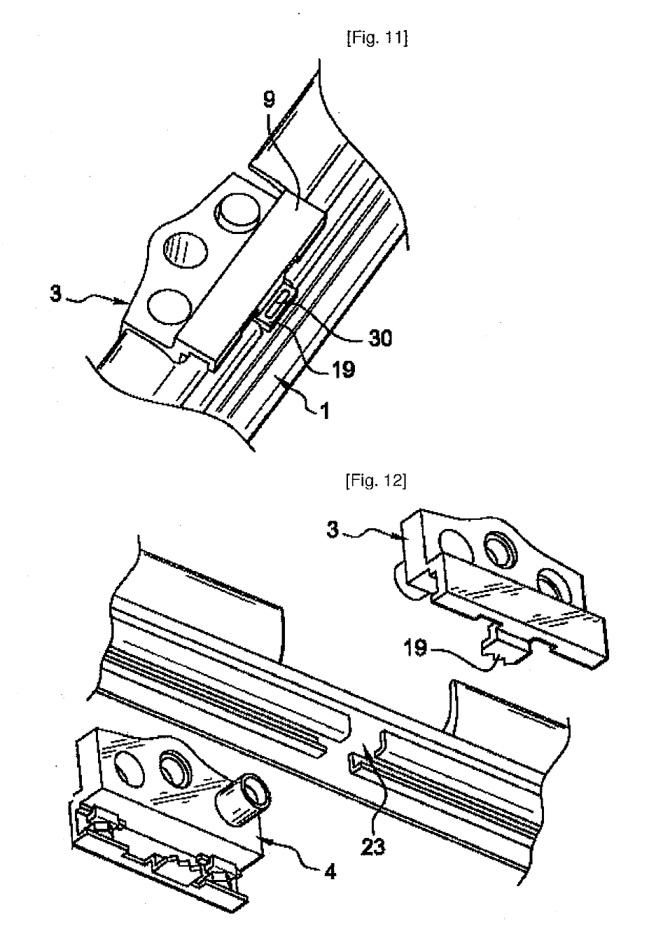

While referring to FIGS. 10 and 11, the assembly is attached by a locking pin 30 having a straight section matching the holes 28 and 29 provided on the lugs 19 and 20.

The locking pin 30 forms an extended parallelepiped flat plate. It can be made of metal or plastic material.

It is preferably inserted, with a slight friction, successively in the orifice of the lug 19, the hole 23 provided on the blade 1, the orifice 29 on the other lug 20. The length of the locking pin 30 (in the longitudinal direction and as observed transversely to the blade) is such that it does not go beyond the lugs 19 and 20 once the assembly is made (FIG. 11).

FIG. 10a shows an alternative embodiment of the locking pin 30a having a general cylindrical form. The locking pin 30a includes a central rod 35a and end parts 36a and 37a which protrude, more particularly having a cylindrical form, and a diameter smaller than the diameter of the rod 35a.

The orifice 23 of the wiper blade 1 wherein the locking pin 30a is able to be inserted and more precisely the rod 35a has a matching shape (in fact a cylindrical shape.)

This is also true for the holes 28 and 29 (cylindrical) provided on the lugs 19, 20 of each connector half, the diameter of the end parts 6a and 37a being substantially equal to the diameter of the holes 28, 29 on the side lugs 19, 20.

It also possible to adapt the size of the protruding end parts 36a and 37a and more precisely their diameter as a function of the distance between the lugs 19, 20 and the blade 1.

In FIG. 10a, it can be seen that one of the end parts 36a has a greater length (in the longitudinal direction of the locking pin 30a) than the other one 37a. This different length makes it possible to take into account that the distance between the blade 1 and the lugs 19, 20 can be bigger on one side than on the other side.

The length of the central rod 35a substantially corresponds to the width (transversally) of the blade 1.

Notches can be provided on at least a part of the surface of the end parts which protrude 36a, 37a in FIG. 10a, able to engage with other notches provided on the inner surface of the hole 28, 29 of the lugs 19, 20, thus allowing a better support of the locking pin 30a therein.

In an alternative solution, the orifice 23 of the blade 1 is formed directly by inserting the locking pin 30a into the blade 1 through the holes 28, 29. Such operation is easily carried out because of:
the small diameter of the end parts 36a and 37a;
the small difference in diameters between those parts and the rod 35a and;
the locking pin is made of metal and the blade 1 is made of elastomer.

Besides, because of the small diameter of the lug 35a its presence does not interfere with the flexibility of the blade 1.

The device of the invention secures a reliable connection since the locking pin cannot be disengaged fortuitously.

FIGS. 12 to 14 show still another alternative embodiment at various steps of the assembling. The identical or similar components bear the same reference numbers as in the previous Figures.

The embodiment of FIGS. 12 to 14 is different from that of FIGS. 1 to 11 in the shape of the lugs 19 and 20 which are in fact very similar to those of FIGS. 1 to 4, except for the fact that they include, each, indentations in the distal part intended to come opposite each other when the assembly is completed. (FIG. 14).

1. A device for supporting and attaching a wiper blade and a blade mounting thereof on a wiper carrier, the device comprising:
a connector comprising two halves connectable to each other and configured in a connected position to support and lock the blade and said blade mounting,
wherein each connector half comprises a projecting component configured to engage with a matching component, one on said blade and the other on said mounting respectively.

2. The device according to claim 1, wherein both connector halves are identical.

3. The device according to claim 1, wherein a notch configured to engage with a corresponding projecting lug provided on each connector half is provided on either side of said mounting.

4. The device according to claim 3, wherein a distal end of one lug provided on one connector half is able to abut against a distal end of another lug provided on the other connector half in a connected position of the connector halves.

5. The device according to claim 3, wherein the distal end of a lug of a connector half comprises a second projecting component configured to engage with a notch provided on the other lug of the other connector half.

6. The device according to claim 1, wherein the blade comprises a through hole in a transversal direction.

7. The device according to claim 5, wherein each lug provided on each connector half comprises a hole, and a locking pin is provided which is configured in the connected position to go through both lugs, the hole in the blade, and the notches of the mounting.

8. The device according to claim 3, wherein each lug provided on the connector halves is provided with a blade locking means, the blade having no hole.

9. The device according to claim 8, wherein the locking means comprises at least one prong or teeth tooth on the distal edge of each lug.

10. A windscreen wiper assembly comprising:
a blade;
a blade mounting thereof; and
a connecting device for supporting and attaching the blade and the blade mounting on a wiper carrier, the connecting device comprising:
a connector comprising two halves connectable to each other and configured in a connected position to support and lock the blade and said blade mounting,
wherein each connector half comprises a projecting component configured to engage with a matching component, one on said blade and the other on said mounting respectively.

11. The device according to claim 2, wherein a notch configured to engage with a corresponding projecting lug provided on each connector half is provided on either side of said mounting.

12. The device according to claim 2, wherein the blade comprises a through hole in a transversal direction.

13. The device according to claim 3, wherein the blade comprises a through hole in a transversal direction.

14. The device according to claim 4, wherein the distal end of a lug of a connector half comprises a second projecting component configured to engage with a notch provided on the other lug of the other connector half.

15. The device according to claim 4, wherein each lug provided on the connector halves is provided with a blade locking means, the blade having no hole.

16. The device according to claim 5, wherein each lug provided on the connector halves is provided with a blade locking means, the blade having no hole.

17. The device according to claim 11, wherein a distal end of one lug provided on one connector half is able to abut against a distal end of another lug provided on the other connector half in a connected position of the connector halves.

18. The device according to claim 11, wherein the distal end of a lug of a connector half comprises a second projecting component configured to engage with a notch provided on the other lug of the other connector half.

19. The device according to claim 14, wherein each lug provided on each connector half comprises a hole, and a locking pin is provided which is configured in the connected position to go through both lugs, the hole in the blade, and the notches of the mounting.

20. The device according to claim 15, wherein the locking means comprises at least one prong or tooth on the distal edge of each lug.
